(19) United States
(12) Patent Application Publication
(10) Pub. No.: US 2009/0228697 A1
(43) Pub. Date: Sep. 10, 2009

(54) INFORMATION PROCESSING APPARATUS, STORAGE DRIVE AND FIRMWARE UPDATE METHOD

(75) Inventor: Takehiko Kurashige, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/391,138

(22) Filed: Feb. 23, 2009

Related U.S. Application Data
(63) Continuation of application No. PCT/JP2008/071173, filed on Nov. 14, 2008.

(30) Foreign Application Priority Data
Mar. 7, 2008 (JP) 2008-058541

(51) Int. Cl. G06F 9/00

(52) U.S. Cl. 713/100

(57) ABSTRACT

According to one embodiment, an information processing apparatus includes an main body and a storage drive which is accommodated in the main body. The main body includes a download control module which externally acquires an unencrypted plain-text header of a firmware module including the plain-text header and an encrypted firmware body, and determines correctness of the firmware module based on comparison between firmware revision information included in the plain-text header and firmware revision information of an existing firmware acquired from the storage drive. The storage drive includes a memory control module which receives the firmware module from the main body, decodes the encrypted firmware body, and rewrites the existing firmware stored in a storage memory as updated firmware using the firmware body when the firmware module is determined as correct based on comparison between information included in the decoded firmware body and information included in the plain-text header.

### CROSS REFERENCE TO RELATED APPLICATIONS

This is a Continuation Application of PCT Application No. PCT/JP2008/071173, filed Nov. 14, 2008, which was published under PCT Article 21(2) in English.

This application is based upon and claims the benefit of priority from Japanese Patent Application No. 2008-058541, filed Mar. 7, 2008, the entire contents of which are incorporated herein by reference.

### BACKGROUND

1. Field

One embodiment of the invention relates to an information processing apparatus, a storage drive and a firmware update method.

2. Description of the Related Art

As a conventional information processing apparatus, one which reads a program including an unencrypted plain-text header and an encrypted body and records the program after judging correctness of the program is known (see International Publication No. 02/057904).

Such an information processing apparatus includes a first storage section which stores an execution program in advance, a second storage section which stores module identification information, a first control section which receives a download module encrypted with an encryption key created from the execution program and the module identification information and stores the download module in the second storage section, and a second control section which decodes the download module with an encryption key created from the execution program in the first storage section and the download module in the second storage section, and rewrites the execution program in the first storage section as a new execution program included in the download module when a storing start address, a data length, and a checksum included in the download module are correct values. Thereby, a program to be downloaded can be prevented from being decoded. Further, by encrypting a download module using a prestored execution program, comparison between a new execution program included in the download module and the prestored execution program can be made, which prevents erroneous downloading.

In a conventional information processing apparatus, however, since version information of an execution program is described in a plain-text header and can be easily rewritten, the execution program might be incorrectly used. Further, the file size of the download module is not described in the plain-text header. When the download module is divided and stored in a second storage section, for example, it is difficult for the second storage section to judge storage completion of the download module.

The present invention has been made in consideration of the above, and an object of the invention is to provide an information processing apparatus, a storage drive, and a firmware update method capable of preventing decryption of programs to be downloaded and incorrect use of programs, and causes the storage drive to judge reception completion of programs.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an external appearance of an information processing apparatus 1 according to an embodiment of the invention;

FIG. 2 is an exemplary block diagram showing a schematic configuration of the information processing apparatus according to the embodiment;

FIG. 3 is an exemplary block diagram showing a schematic configuration of a solid-sate drive (SSD) according to the embodiment;

FIGS. 4A, 4B and 4C are exemplary schematic views showing a configuration of a firmware module according to the embodiment;

FIG. 5 is an exemplary schematic view showing a configuration of a firmware module according to the embodiment;

FIG. 6 is an exemplary flowchart showing an operation of a host device according to the embodiment; and

FIG. 7 is an exemplary flowchart showing an operation of an SSD according to the embodiment.

### DETAILED DESCRIPTION

Various embodiments according to the invention will be described hereinafter with reference to the accompanying drawings. In general, according to one embodiment of the Invention, an information processing apparatus includes an information processing apparatus main body and a storage drive which is accommodated in the information processing apparatus main body. The information processing apparatus main body includes a communication module, and a download control module which externally acquires an unencrypted plain-text header of a firmware module including the plain-text header and an encrypted firmware body by means of the communication module, and determines correctness of the firmware module based on comparison between firmware revision information included in the plain-text header and firmware revision information of an existing firmware acquired from the storage drive, when an operation to instruct update of a firmware stored in the storage drive is made. The storage drive includes a storage memory which rewritably stores the firmware, and a memory control module which receives the firmware module from the information processing apparatus main body, decodes the encrypted firmware body, and rewrites the existing firmware stored in the storage memory as updated firmware using the firmware body when the firmware module is determined as correct based on comparison between information included in the decoded firmware body and information included in the plain-text header.

### Configuration of Information Processing Apparatus

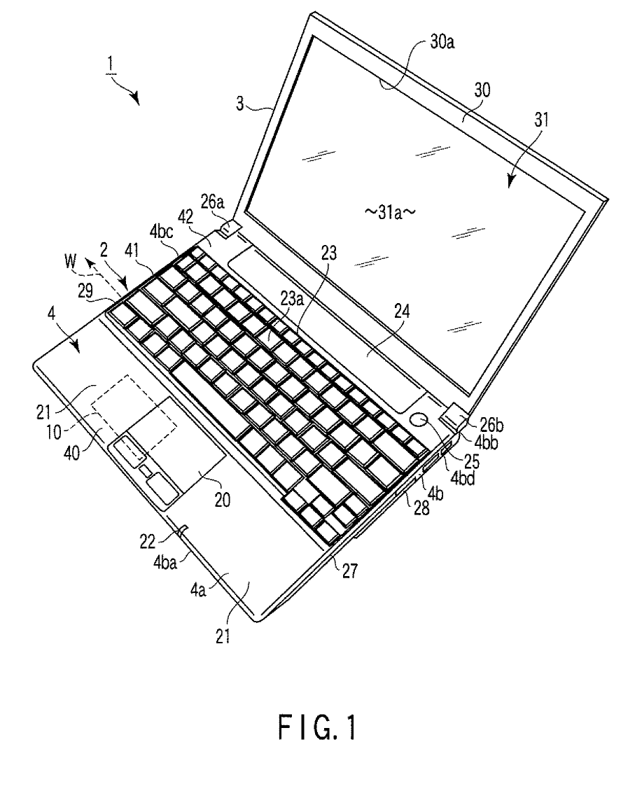

FIG. 1 is an exemplary perspective view showing an external appearance of an information processing apparatus 1 according to an embodiment of the invention.

The information processing apparatus 1 is composed of a main body 2 and a display unit 3 attached to the main body 2.

The main body 2 has a box-shaped housing 4, and the housing 4 includes a top wall 4a, a peripheral wall 4b and a bottom wall (not shown). The top wall 4a of the housing 4 includes a front part 40, a central part 41 and a back part 42 which are arranged in order from a side close to a user who operates the information processing apparatus 1. The bottom wall faces an installation surface on which the information processing apparatus 1 is placed. The peripheral wall 4b includes a front wall 4ba, a rear wall 4bb, and right and left side walls 4bc, 4bd.

The front part 40 includes a touch pad 20 which is a pointing device, a palm rest 21, and a liquid crystal display (LED) 22 which illuminates in conjunction with an operation of each of the components of the information processing apparatus 1.

The central part 41 includes a keyboard mounting part 23 on which a keyboard 23a capable of inputting character information, etc., is mounted.

The back part 42 includes a battery pack 24 which is detachably attached, a power switch 25 for turning on the power of the information processing apparatus 1 on the right side of the battery pack 24, and a pair of hinge portions 26a, 26b which rotatably supports the display unit 3 at the right and left sides of the battery pack 24.

An exhaust port 29 for exhausting wind “W” from the inside of the housing 4 to the outside thereof is disposed on the left sidewall 4bc of the housing 4. An optical disc drive (ODD) 27 capable of reading/writing data from/to an optical storage medium such as a DVD, and a card slot 28 in/from which various cards are inserted/removed are disposed on the right sidewall 4bd.

The housing 4 is formed of a housing cover including a part of the peripheral wall 4b and the top wall 4a, and a housing base including a part of the peripheral wall 4b and the bottom wall. The housing cover is detachably coupled to the housing base to form a housing space along with the housing base. The housing space houses a solid-state drive (SSD) 10, etc., as a non-volatile semiconductor memory drive. Details of the SSD 10 will be described later.

The display unit 3 includes a display housing 30 including an opening 30a and a display device 31 composed of an LCD, etc., capable of displaying images on a display 31a. The display device 31 is housed in the display housing 30, and the display 31a is exposed to the outside of the display housing 30 through the opening 30a.

In the housing 4, a main circuit board, an expansion module, a fan, etc., not shown, are housed, as well as the SSD 10, the battery pack 24, the ODD 27 and the card slot 28.

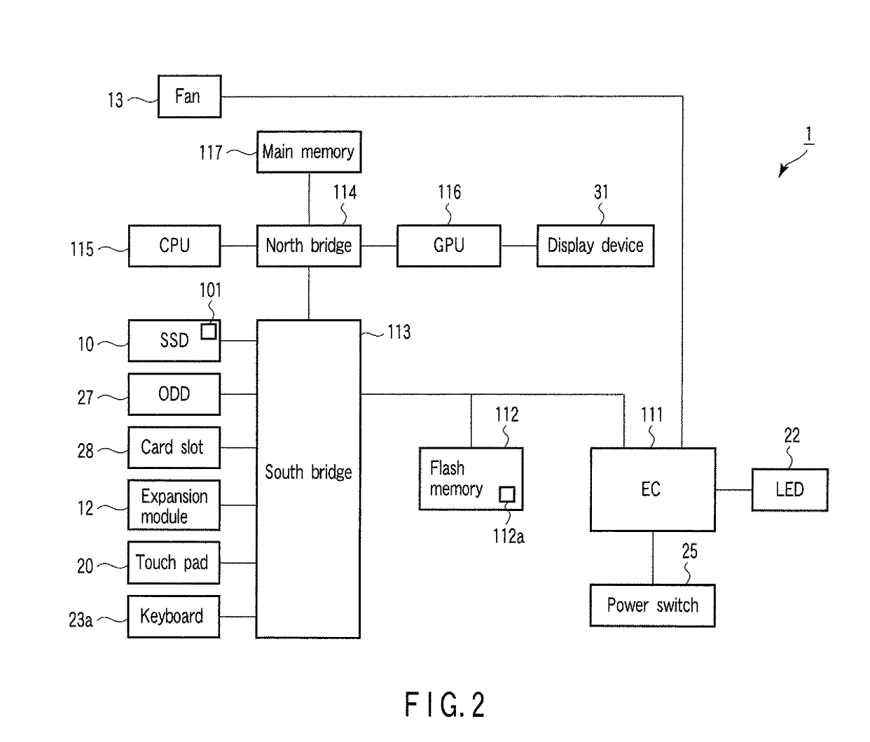

FIG. 2 is an exemplary block diagram showing a schematic configuration of an information processing apparatus 1 according to an embodiment of the invention.

The information processing apparatus 1 includes an embedded controller (EC) 111 which is an embedded system for controlling each component, a flash memory 112 which stores a basic input/output system (BIOS) 112a, a south bridge 113 which is a large scale integration (LSI) chip and functions as various bus controllers and as an I/O controller (main controller) a north bridge 114, which is an LSI chip, for controlling connections among a central processing unit (CPU) 115 to be described later, a graphics processing unit (GPU) 116, a main memory 117, and various buses, a CPU 115 which computes various signals, the CPU 116 which controls and computes video signals for display, and a main memory 117 read and written by the CPU 115, as well as the SSD 10, the extension module 12, the fan 13, the touch pad 20, the keyboard 23a, the LED 22, the power switch 25, the ODD 27, the card slot 28 and the display device.

The expansion module 12 includes an expansion circuit board, a card socket mounted on the expansion circuit board, and an expansion module board inserted in the card socket. The card socket is based on the standard of Mini-PCI, etc., and the expansion module board may be a third generation (3G) module, a television tuner, a GPS module, a Wimax (trademark) module and a wireless LAN module. In the embodiment, the expansion module 12 is a wireless LAN module, for example, which functions as a communication section.

The fan 13 is a cooling unit which cools the inside of the housing 4 by means of ventilation, and exhausets the air in the housing 4 to the outside as wind “W” via the exhaust port 29.

The EC 111, the flash memory 112, the south bridge 113, the north bridge 114, the CPU 115, the GPU 116 and the main memory 117 are the electronic components mounted on the main circuit board.

The SSD 10 is an external storage device which stores data and programs and from which records are not lost even if the power is not supplied thereto. Although the SSD 10 has no drive mechanism such as a magnetic disc or a head like a conventional hard disk drive, the SSD 10 stores program such as an operating system (OS), data generated by a user or executing software, etc., readably and secularly in the storage areas of the NAND memories in the same way as that of the hard disk drive, and is a drive composed of a non-volatile semiconductor memory capable of operating as a boot drive of the information processing apparatus 1.

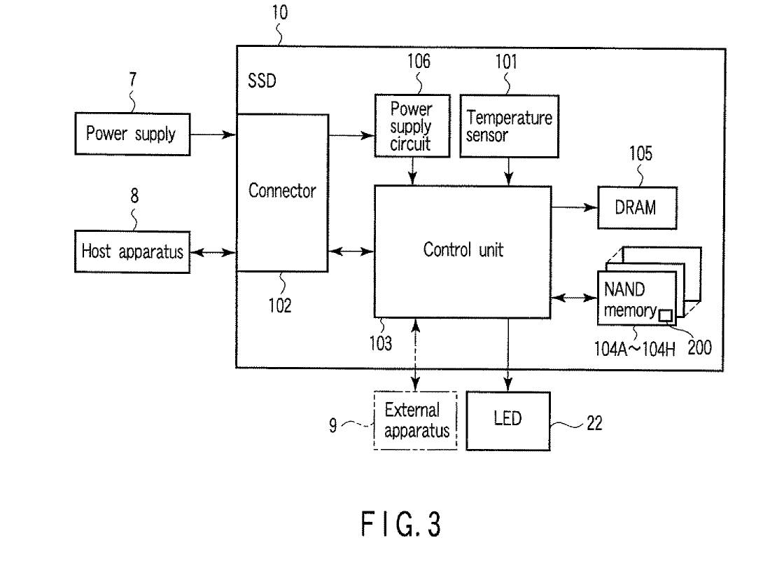

FIG. 3 is an exemplary block diagram showing a schematic configuration of the SSD 10 according to an embodiment of the invention.

The control unit 103 as a memory controller is connected to each of the temperature sensor 101, the connector 102, the eight NAND memories 104A-104H, the DRAM 105 and the power supply circuit 106. The controller 103 is connected to the host apparatus 8 via the connector 102, and is connected to an external device 9, as necessary.

The power supply 7 is a battery pack 24 or an AC adaptor, not shown, and 3.3V DC is supplied to the power supply circuit 106 via the connector 102, for example. Further, the power supply 7 supplies power to the entire of the information processing apparatus 1.

The host apparatus 8 is the information processing apparatus 1, in this embodiment, and the south bridge 113 mounted on the main circuit board is connected to the control unit 103. Data transmission is made between the south bridge 113 and the controller 103 based on a standard of a serial ATA, for example.

The external apparatus 9 is an information processing apparatus differing from the information processing apparatus 1. With respect to the SSD 10 detached from the information processing apparatus 1, the external apparatus 9 is connected to the control unit 103 based on the standard of an RS-232C, for example, and has a function of reading data stored in the NAND memories 104A-104H.

The board on which the SSD 10 is mounted has, for example, the same outer shape and size as that of a hard disk drive (HDD) of a 1.8-inch type or a 2.5-inch type. In this embodiment, the outer shape and size is the same as that of the 1.8-inch type.

The temperature sensor 101 is provided between the control unit 103 and the NAND memories 104A-104H, which are also heat sources, on the board. In the embodiment, the temperature sensor 101 is provided near the center of the substrate to be surrounded by the control unit 103 and the NAND memories 104A-104H, and measures the temperature in that position. The temperature measured by the temperature sensor 101 is transmitted as temperature information to the control unit 103. In the embodiment, a semiconductor temperature sensor utilizing the characteristic that a PN junction of a semiconductor changes in voltage according to the temperature is used. However, a temperature sensor based on other systems such as a thermistor may be used.

The temperature measured by the temperature sensor 101 provided in the above-described position is 50-60° C., for example, when the SSD 10 is activated, and is higher than the temperature of other areas of the substrate 100 by about 10° C.

The control unit 103 controls operations of the NAND memories 104A-104H. More specifically, the control unit 103 controls reading/writing of data from/to the NAND memories 104A-104H in response to a request from the host apparatus 8. The data-transmission speed is 100 MB/sec in data reading and 40 MB/sec in data writing, for example.

The control unit 103 acquires temperature information from the temperature sensor 101 at predetermined intervals, and decreases the response time to the host apparatus 8 when the measured temperature indicated by the temperature information exceeds a preset specified value. The operation of decreasing the response time includes decreasing the transmission rate at the time of transmission of data read from the NAND memories 104A-104H to the host apparatus 8 and decreasing the transmission rate between the control unit 103 and the NAND memories 104A-104H, for example, as operations for partially restricting processing capabilities of the SSD 10.

Further, when the measured temperature exceeds the specified value, the control unit 103 outputs an alert signal as information indicative of the excess to the host apparatus 8. The control unit 103 may output the temperature information itself in place of the alert signal to the host apparatus 8.

Further, the control unit 103 writes the acquired temperature information into a specific address of each of the NAND memories 104A-104H along with the acquired time and date.

Each of the NAND memories 104A-104H is, for example, a non-volatile semiconductor memory with 16 GB as a storage capacity, and is, for example, a multi level cell (MLC)-NAND memory (multi-level NAND memory) capable of 2-bit recording in one memory cell. The MLC-NAND memory generally has no advantage over rewritable times as compared with a signal level cell (SLC)-NAND memory, but the storage capacity can be easily increased. Further, the NAND memories 104A-104H have the characteristic that the period during which data can be held changes according to the temperature of the environment in which the NAND memories 104A-104H are placed.

The NAND memories 104A-104H store data, temperature information, and acquired date and time written under the control of the control unit 103, and store firmware 200 for operating the SSD 10. Further, the firmware 200 has a firmware revision as its own version information.

The DRAM 105 is a buffer in which the data is temporarily stored at the time of data reading/writing from/to the NAND memories 104A-104H according to control of the control unit 103.

The connector 102 has a shape based on the standards such as a serial ATA. The control unit 103 and the power supply circuit 106 may be connected to the host apparatus 8 and the power supply 7, respectively, via different connectors.

The power circuit 106 converts 3.3V DC supplied from the power supply 7 to DC 1.8V, 1.2V DC, for example, and supplies the three kinds of voltages to each component according to the drive voltage of each component of the SSD 10.

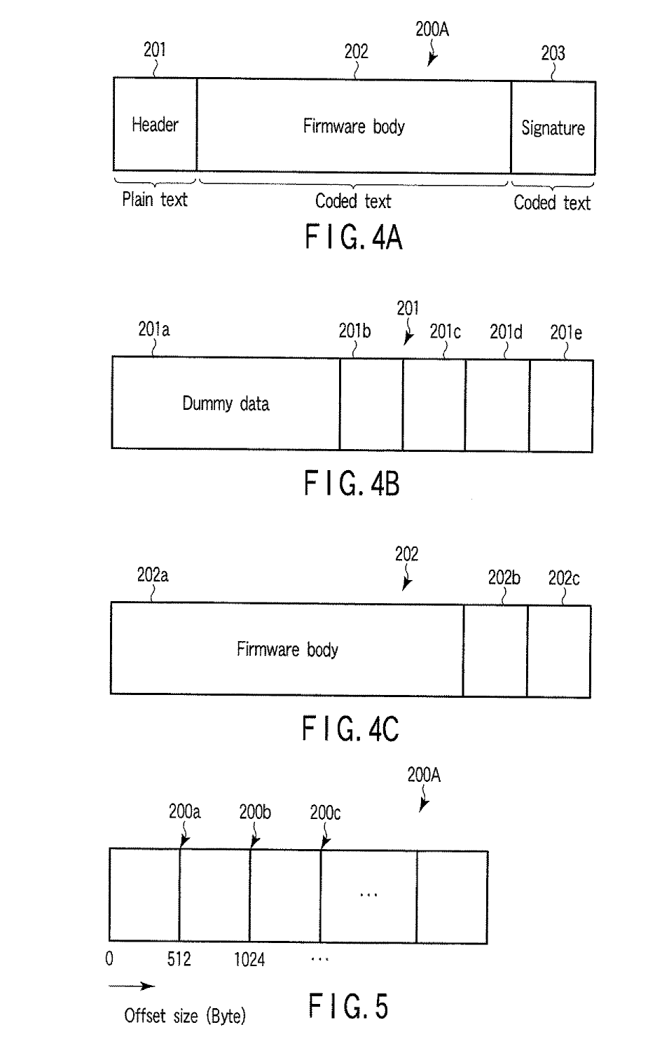

FIGS. 4A, 4B and 4C are schematic views showing configurations of a firmware module according to an embodiment of the invention.

A firmware module 200A is a program acquired by a communication with an external network connected to a wireless LAN module as an extension module 12 of the information processing apparatus 1, and updates the firmware 200 of the SSD 10.

Further, the firmware module 200A includes a header 201 formed of an unencrypted plain text, an encrypted firmware body 202, and a signature 203, as shown in FIG. 4A.

The header 201 has a data size of a fixed length, and includes dummy data 201a for compensating for the fixed length, a firmware file size 201b describing the file size of the firmware body 202a, which will be described later, a firmware revision 201c which describes version information, for example, of the firmware body 202, a reserved area 201d, and a checksum 201e for error defection of the header 201, as shown in FIG. 4B.

The firmware body 202 includes a firmware text 202a for rewriting the firmware 200, a firmware file size 202b which describes the file size of the firmware text 202a, and a firmware revision 202c which describes version information, for example, of the firmware body 202, as shown in FIG. 4C.

The signature 203 is signature information encrypted with a public key for transmittance proof of the firmware module 200A and correctness assurance of the firmware module 200A.

FIG. 5 is an exemplary schematic view showing a configuration of a firmware module according to an embodiment of the invention.

The firmware module 200A is divided into a plurality of files in a predetermined offset size such as 512 bytes, and received by the information processing apparatus 1 and the SSD 10. Further, the divided files of the firmware module 200A are given offsets 200a, 200b, 200c . . . in an offset size from the head of the firmware module 200A.

### Operation

Hereinafter, an operation of the information processing apparatus according to an embodiment of the invention will be described with reference to the drawings.

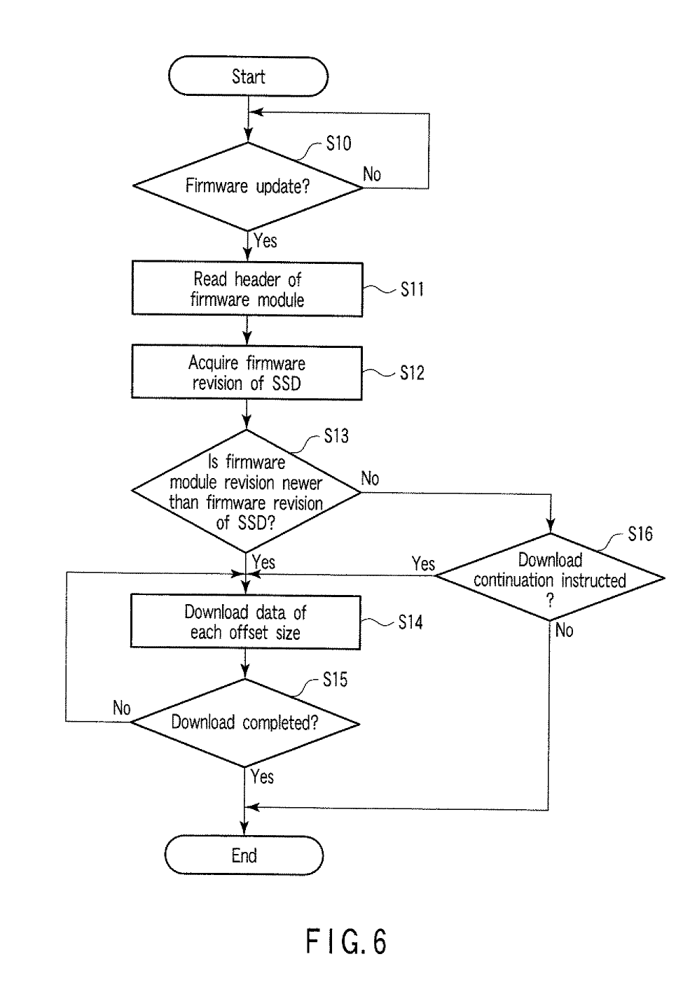

FIG. 6 is an exemplary flowchart showing an operation of the host device according to an embodiment of the invention.

The information processing apparatus 1 as the host apparatus 8 reads the header 201 of the firmware module 200A, when an operation to read the firmware module 200A via the extension module 12 as a wireless LAN module, for example, via the Internet from an external server, and to update the existing firmware to new firmware containing new version information is made by the user via the touchpad 20 or the keyboard 23a (Yes in S10, S11).

Next, the information processing apparatus 1 accesses the firmware 200 of the SSD 10 and acquires a firmware revision of the firmware 200 (S12). After comparison between the firmware revision 201c included in the header 201 of the firmware module 200A and the firmware revision of the firmware 200, if the version information of the firmware module 200A is newer (Yes in S13), the information processing apparatus 1 downloads each item of data divided by the offsets 200a-200c of the firmware module 200A via the extension module 12 as a communication section (S14).

If the version information of the firmware module 200A is not newer in block S13 (No in S13), the information processing apparatus 1 displays, on the display device 31, confirmation of whether to continue downloading or not, and if the user instructs continuation of downloading via the touchpad 20, the keyboard 23a, or the like (Yes in S16), downloads each item of data divided by the offsets 200a-200c of the firmware module 200A (S14).

If the download continuation instruction is not made by the user in block S16 (No in S16), the information processing apparatus 1 ends the update operation.

The information processing apparatus 1 repeats block S14 to download the firmware module 200A (No in S15). After downloading all the items of data of the firmware module 200A (Yes in S15), the information processing apparatus 1 ends the update operation.

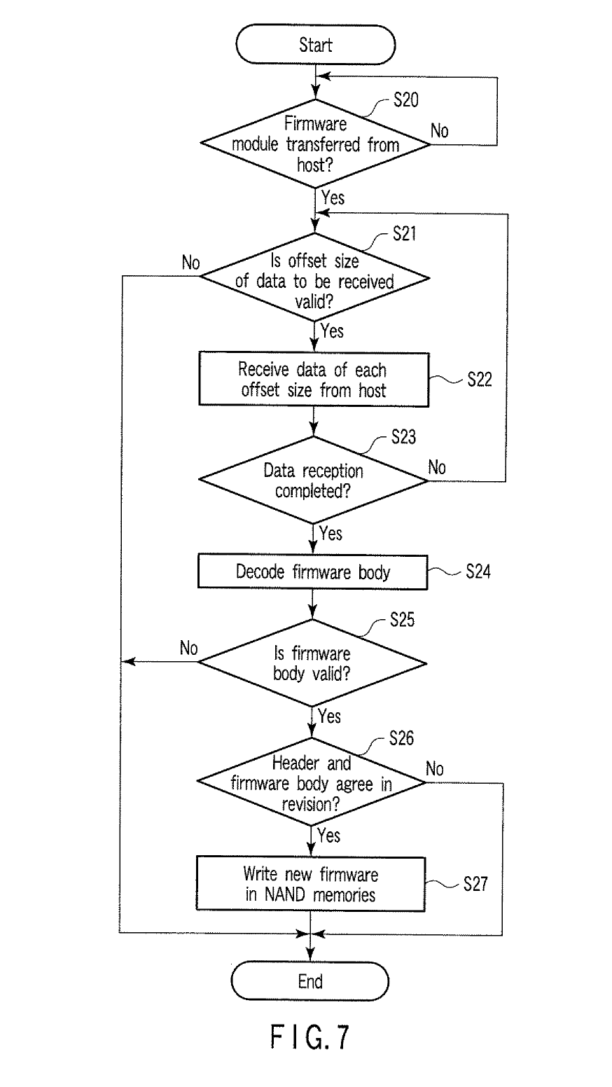

FIG. 7 is an exemplary flowchart showing an operation of the SSD according to an embodiment of the invention.

When the firmware module 200A is transmitted from the host apparatus 8 via the connector 102 (Yes in S20), the control unit 103 of the SSD 10 confirms the offset size of data to be received. If the offset size is valid (Yes in S21), the control unit 103 receives data of each offset size and stores the data in the DRAM 105 (S22). If the offset size is not appropriate (No in S21), the information processing apparatus 1 ends the update operation.

The control unit 103 confirms whether all the items of data of the firmware module 200A have been received by comparison between the firmware file size 201b of the header 201 and the data size of the received firmware module 200A, and if not all the items of data of the firmware module 200A have been received (No in S23), repeats the blocks S21-S22.

Upon confirmation that the firmware file size 201b of the header 201 and the data size of the received firmware module 200A agree and that all the items of data of the firmware module 200A have been received (S23) , the control unit 103 decodes the firmware body 202 (S24), and executes confirmation of agreement between the firmware file sizes 201b and 202b and validity of the signature 203 and the checksum 201e (S25).

Next, if the firmware revision 201c of the header 201 and the firmware revision 202c of the firmware body 202 agree as a result of comparison therebetween (Yes in S26), the firmware 200 of the NAND memories 104A-104H is rewritten as a new firmware using a firmware body 202a, and the new firmware is written therein (S27).

### Advantages of Embodiment

According to the above-described embodiment, since the firmware 200 of the NAND memories is rewritten only when the plain text header 201 and the firmware revisions 201c and 202c of the encrypted firmware body 202 agree, incorrect use of programs can be prevented, and version information, for example, of the firmware module 200A can be confirmed by the host apparatus 8 which does not decrypt the firmware body 202 using the plain-text header 20l. Further, since the firmware body 202 is decrypted, decoding of programs to be downloaded can be prevented.

Further, since the controller 103 confirms reception completion of the firmware module 200A from the host apparatus 8 by confirming agreement between the firmware file size 201b of the header 201 and the data size of the firmware module 200A, it is not necessary to decode each divided item of data of the firmware module 200A to confirm agreement in data size, thereby reducing the load at the time of reception operation of the SSD 10.

The present invention is not limited to a non-volatile semiconductor memory drive, and can be applied to any device which operates by firmware. Further, the present invention may be applied to a general program as well as firmware.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions

What is claimed is:

1. An information processing apparatus comprising:
an information processing apparatus main body; and
a storage drive which is accommodated in the information processing apparatus main body,
the information processing apparatus main body including:
a communication module; and
a download control module configured to externally acquire an unencrypted plain-text header of a firmware module including the plaintext header and an encrypted firmware body by means of the communication module, and determines correctness of the firmware module based on comparison between firmware revision information included in the plain-text header and firmware revision information of an existing firmware acquired from the storage drive, when an operation to instruct update of a firmware stored in the storage drive is made, and
the storage drive including:
a storage memory which rewritably stores the firmware; and
a memory control module configured to receive the firmware module from the information processing apparatus main body, to decode the encrypted firmware body, and to rewrite the existing firmware stored in the storage memory as updated firmware using the firmware body when the firmware module is determined as correct based on comparison between information included in the decoded firmware body and information included in the plain-text header.

2. The information processing apparatus of claim 1, wherein the storage drive is a non-volatile semiconductor memory drive.

3. The information processing apparatus of claim 1, wherein the memory control module of the storage drive determines correctness of the firmware module based on comparison between firmware revision information included in the plain-text header and firmware revision information of the decoded firmware body.

4. The information processing apparatus of claim 1, wherein the memory control module of the storage drive determines correctness of the firmware module based on comparison between file size information included in the plain-text header and firmware file size information included in the decoded firmware body.

5. The information processing apparatus of claim 1, wherein the memory control module of the storage drive determines reception completion of the divided firmware module based on firmware file size information included in the plain-text header, when the firmware module is divided and received from the information processing apparatus body.

6. A storage drive which is accommodated in an information processing apparatus main body, comprising:
a storage memory which rewritably stores the firmware; and
a memory control module configured to receive a firmware module including an unencrypted plain-text header and an encrypted firmware body, to decode the encrypted firmware body, and to rewrite an existing firmware stored in the storage memory as updated firmware using a firmware body when the firmware module is determined as correct based on comparison between information included in the decoded firmware body and information included in the plain-text header.

7. The storage drive of claim 6, wherein the storage drive is a non-volatile semiconductor memory drive.

8. The storage drive of claim 6, wherein the memory control module determines correctness of the firmware module based on comparison between firmware revision information included in the plain-text header and firmware revision information of the decoded firmware body.

9. The storage drive of claim 6, wherein the memory control module determines correctness of the firmware module based on comparison between firmware file size information included in the plain-text header and firmware file size information included in the decoded firmware body.

10. The storage drive of claim 6, wherein the memory control module determines reception completion of the divided firmware module based on firmware file size information included in the plain-text header, when the firmware module Is divided and received from the information processing apparatus body.

11. A firmware update method of an information processing apparatus including an information processing apparatus main body and a storage drive which is accommodated in the information processing apparatus main body, the method comprising:
externally acquiring, by the information processing apparatus main body, an unencrypted plain-text header of a firmware module including the plain-text header and an encrypted firmware body by means of a communication means, and determining correctness of the firmware module based on comparison between firmware revision information included in the plain-text header and firmware revision information of an existing firmware acquired from the storage drive, when an operation to instruct update of a firmware stored in the storage drive is made, and,
receiving, by the storage drive, the firmware module from the information processing apparatus body, decoding the encrypted firmware body, and rewriting the existing firmware stored in a storage memory as updated firmware using the firmware body when the firmware module is determined as correct based on comparison between information included in the decoded firmware body and information included in the plain-text header.
